(19) United States
(12) Patent Application Publication
(10) Pub. No.: US 2026/0219689 A1
(43) Pub. Date: Jul. 30, 2026

(54) ROBOTIC ALL-TERRAIN SYSTEM FOR STORING AND DISTRIBUTING GOODS

(71) Applicant: Igor Sergeevich LERNER, Yaroslavl (RU)

(72) Inventor: Igor Sergeevich LERNER, Yaroslavl (RU)

(21) Appl. No.: 18/878,945

(22) PCT Filed: Jun. 2, 2023
(86) PCT No.: PCT/RU2023/000171

§ 371 Date: Dec. 26, 2024

(30) Foreign Application Priority Data
Jun. 15, 2022 (RU) 2022116077

(51) Int. Cl. G05D 1/667; B65G 1/137; G05D 105/28

(52) U.S. Cl. CPC G05D 1/667; B65G 1/137; G05D 2105/28

(57) ABSTRACT

A self-propelled vehicle for distributing goods is proposed, which is configured as a driverless all-terrain cargo vehicle. The vehicle comprises the following interacting subsystems: a navigation and steering subsystem, a goods display and distribution subsystem, and a delivery subsystem, having remotely controlled equipment with a self-adjusting functional for allowing the viewing of goods by a consumer and receipt of a chosen category of goods. The navigation and steering subsystem contains a unit for controlling the vehicle movement, and a unit for controlling autonomously operable components. A robotic manipulator mechanism of the goods display and distribution subsystem has a working member for gripping a good to allow viewing thereof and loading and unloading of the good onto the delivery subsystem, the latter having temporarily detachable ground and aerial vehicles. This allows fast and accurate preparation of chosen sets of goods using an established algorithm, as well as their careful storage.

### TECHNICAL FIELD

The proposed invention relates to the field of mobile smart systems designed to operate in the retail distribution of the most popular product categories to consumers predominantly residing outside the boundaries of urban settlements, in a significant distance from fixed network and local retail outlets.

### BACKGROUND OF THE INVENTION

Currently, the world is witnessing a trend of active development of robotic equipment and auxiliary smart systems of managerial type, which are universally implemented in significant areas of industry related to energy, information technology, healthcare, etc.

It should also be noted the successful application of robotic smart machines in the economic and service spheres, for example, robot vacuum cleaners and household humanoid robots-assistants are well established in the market and now their design is quite promising and has great investment attractiveness.

A significant share of the market is occupied by robotic smart devices used in the segment of transport and logistics processes, such as ground and airborne delivery robots capable of delivering goods to recipients and returning to their base points in an automatic mode. Airborne robots are quadcopters, drones and similar vehicles equipped with propellers, while ground robots are technical units using wheeled, caterpillar or other mechanical means as propulsion.

Ground and airborne robots have become particularly popular in recent years for delivering food to consumers, successfully replacing the usual delivery services specializing in courier delivery of food. However, the operation of such devices is associated with a number of technological difficulties, in particular, consisting in the need to maintain a stationary central control and maintenance center where technical work could be carried out to maintain the functionality of smart machines.

The existing problem has been partially solved, and there are developments in the prior art which involve stationary control and service centers, but these solutions can function mainly in large cities and serve a limited area.

There are also mobile independent systems for the maintenance and management of ground and airborne vehicles delivering parcels, but they are also not without disadvantages.

The technical features and disadvantages of the prior art technical solutions will be discussed further by way of examples.

A robotic system comprising a ground vehicle and an airborne vehicle is known from the prior art (see U.S. Pat. No. 1,089,0921, IPC A63F 9/24, publ. 2019-hereinafter [1]).

As indicated, the robotic system known from [1] includes the ground vehicle in the form of an autonomous rechargeable robot whose propulsion capabilities are implemented by means of a wheel, track or foot drive. The airborne vehicle is provided with a screw drive mechanism to enable movement through an air environment.

The operation of the robotic means is provided and controlled from a control room, and the progress of the operations can be monitored using portable electronic devices, such as a smartphone, smart watch or tablet computer.

The known robotic means are equipped with control systems based on artificial intelligence and are capable of solving a wide range of tasks of different content, of particular importance among which is the ability to address delivery of goods, including groceries, to a final recipient. The mentioned delivery of goods can be carried out by ground, air or combined way.

The ground and airborne vehicles are equipped with special equipment allowing to hold the goods and deliver them to required addresses.

The functioning of delivery robots can be organized in conjunction with a vehicle which, if necessary, brings the products to the nearest permissible area of terrain, after which the delivery robots, in contact with the vehicle, are equipped with parcels and serve a certain delivery area.

The peculiarity of the robotic system known from [1] is the technological possibility of docking of the ground delivery robot and the airborne delivery robot with each other, which forms a kind of combined construction adapted to the combined movement and solution of non-standard logistic tasks as a consequence.

The disadvantage of the system known from [1] should be recognized as low and non-competitive functional operational performance manifested as a consequence of the human-like structure of ground robots, not intended for the movement of bulk goods, and as a consequence of not the best aerodynamic performance of airborne vehicles, affecting negatively on the speed and maneuverability when moving.

An additional disadvantage of the system known from [1] should be considered a forced and technologically complex step-by-step process of docking of the ground and airborne means of movement which, when carrying out work related to goods delivery, can be neglected and, in fact, goods can be delivered by separate components of the system. Besides, said docking implies the necessity of software reconfiguration of the equipment, which increases the time for courier activities.

A food and beverage delivery system based on autonomous and semi-autonomous vehicles is known from the prior art (see CA 3070300, IPC G06Q 10/00, publ. 2019-hereinafter) The development known from [2] relates to private urban systems and can be successfully used in a courier environment to deliver, to consumers, food products ordered by them.

The system known from [2] represents a platform technologically providing autonomous or semi-autonomous modes of operation. As the platform, it is necessary to understand a special cargo vehicle containing compartments for storage and ergonomic delivery of food products and control equipment providing operation of subsystems of the vehicle, including operation of a primary loading mechanism and a distribution system that organizes storage and ergonomically verified distribution of the products.

Among the essential features of this system is the presence of a temperature control module in the storage compartments, which is designed to maintain a required temperature according to the storage conditions of certain categories of goods.

In addition, the platform has a reliable and adapted automation for working with food cargoes, which implies the use of external information services and internal memory components interacting with them and endowed with up-to-date information about the types of products coming for sale for the purposes of their precise positioning and specific choice of storage modes and peculiarities of each product's delivery separately.

An important advantage of the solution known from [2] is the possibility of using, within the framework of the known technology, several vehicles forming a kind of courier transport network capable of serving large territories and covering a wide range of consumers, thereby delivering products of different food content.

As a disadvantage of the system known from [2], it should be noted that there is no possibility of precise address delivery, being limited to the available parking space within the customer's location, which in turn causes the need for the customer to look for a parking place for the vehicle that, in conditions of limited parking space, may be distant from the point of order for a sufficiently remote distance.

The vehicles used are designed solely for travelling in urban areas on asphalt pavement and do not have the ability to move on difficult terrain. In this regard, it should be noted that there is an additional disadvantage of the system known from [2], which means the impracticality and practical impossibility of serving consumers located outside large urban settlements, mainly living in rough terrain.

The prior art also discloses a smart robot-assistant for selling products, which is designed on the basis of a cargo vehicle (see CN 112561623, IPC B25J 11/00, publ. 2021 hereinafter [3]).

The technical solution known from [3] relates to mobile automatic robotic means equipped with computer-controlled equipment enabling loading, storing, moving and final sale of products.

The known solution is a mobile smart vehicle for retail sale of products. The smart vehicle is, as a rule, a cargo vehicle equipped with a necessary set of equipment for loading goods, packaging, temporary storage and retail sale. The work processes are monitored by an integrated management system having necessary hardware and software with the ability to generate control commands for mechanized actuators that sort the products inside the vehicle and feed them to the areas prepared for temporary storage.

Unmanned aerial vehicles travelling through the airspace and programmed to make deliveries of goods located nearby at storage points are used as means of loading directly into the system.

The known system uses functionality to recognize products and to identify, without error, the product being handled at a given time, using in-built image sensors to help the system perform correct operations.

The operation of the known system requires the correct identification of the ordered product, which is supported by measurement control means sending data to an analytical processing unit, resulting in an accurate estimated supply of the required product and its eventual delivery to a required destination.

In the operation of the system known from [3], in particular for the distribution of goods delivered by an unmanned aerial vehicle, a robotic manipulator-arm with a gripping element is used to place the goods into required compartments of the temporary storage space organized in the vehicle.

The disadvantage of the system known from [3] should be recognized as insufficiently elaborated and accordingly uncompetitive functionality of the equipment, which does not allow to carry out ‘aerial’ operations for fast and point delivery of parcels with the help of unmanned aerial vehicles directly into the hands of the customer, thus characterizing this technology as semi-automatic and unable to supply the population with products in an absolute automatic mode, without human assistance.

It should be assumed that an additional disadvantage may be the imperfect design of the applied manipulator-arm which has a rather long and curved arm, at the end of which a gripper is installed. In the description of [3], there is no exhaustive information or basic theoretical data confirming the technical feasibility of successful functioning of this means and solving the task assigned to it and associated with temporary storage and sorting of products in the compartments of the vehicle.

### SUMMARY OF THE INVENTION

The technical problem solved by the proposed invention is the creation of a high-tech productive and at the same time calculable trade fair vehicle having off-road characteristics and communicative capabilities with signs of intelligence, which will allow to supply products to the population mainly living in remote non-urban areas, while providing information support expressed in providing communication with the outside world and feedback from a consumer interested in purchasing any given product.

The technical result of the proposed invention, which is achieved when solving the above-mentioned technical problem, is the realization of the purpose to create an all-terrain technological item endowed with the ability to reach hard-to-reach areas with moderate energy consumption and reduced material costs and to supply, in a highly efficient cyclic mode, products specified by a consumer and coming to the latter according to a developed algorithm providing for careful storage/storage, high-speed collection/preparation and accurate delivery/supply.

The above-indicated technical result is achieved and the existing technical problem is solved by that a self-propelled smart vehicle for retail distribution of displayed products intended for a consumer, primarily located outside the boundaries of infrastructural settlements, is made in the form of a preferably off-road cargo, usually unmanned vehicle systemically distributed into a navigation and steering subsystem, a goods display and distribution subsystem and a delivery subsystem which interact with each other. The combination of these subsystems forms an autonomous and conditionally dispersed, primarily popularization distributing structure having the ability to remotely control the operation of detachable and stationary autonomously operating equipment possessing automatically adaptive functionality for maintaining consumer visibility and the final receipt of a selected category of goods. The navigation and steering subsystem comprises a unit for controlling the movement and localization of the vehicle and a unit for controlling stationary and movable detachable autonomously operating components arranged in the goods display and distribution subsystem and in the delivery subsystem with the ability to temporarily detach individual modules from the subsystems. The coordination and distribution part of the autonomously operating components of the goods display and distribution subsystem is made in the form of at least one controlled robotic manipulator mechanism, the structure of which is based on a structural combination of a supporting upper movable two-axis load platform and a supporting lower movable coordination platform with at least one contact two-axis load platform provided therebetween on a connecting transport bridge. The at least one contact two-axis load platform is equipped with an actuator configured to grip a product for the purpose of controlling its spatial position, including creating the possibility of its visual viewing by means of an existing display section, as well as for the purpose of subsequent loading and unloading positional contact with the autonomously operating components of the delivery subsystem, one part of which is automated auxiliary equipment in the form of buffer systems coordinated with each other and having the possibility of goods distribution and lifting. The automated auxiliary equipment provides the passage, sending and receiving of the other part constituting the temporarily detachable modules in the form of ground and airborne transport means for which stationary landing areas are provided. The stationary landing areas support operability, provide for the possibility of docking/decoupling with the product selected by a user and searching for a spatial position within the framework of the work operation being performed.

According to one of the possible and expedient embodiments of the invention, an additional contact two-axis load platform equipped with a compressor-type packing device for wrapping the products with a protective coating is installed on the connecting transport bridge between the supporting upper two-axis load platform and the supporting lower coordination platform of the robotic manipulator mechanism.

According to one of the possible and promising embodiments of the invention, the contact two-axis load platforms of the robotic manipulator mechanism are mounted on a pivoting stand rotating about an axis.

Also, one of the promising embodiments of the invention is to equip the contact two-axis load platforms of the robotic manipulator mechanism with a magnetic mechanism for their attachment to the connecting transport bridge, allowing rotation of the two-axis load platforms around the axis of the connecting transport bridge.

Efficiently and rationally, if an embodiment of the proposed invention allows that the contacting two-axis load platform of the robotic manipulator mechanism comprises an additional actuator mounted with the possibility of displacement of the working part relative to the base.

According to particular embodiments of the proposed invention, said actuator bases are telescopic and their working parts are equipped with crimping gripping elements.

It is most justified and rational when the ground transport means used in the proposed invention are in the form of delivery robots travelling by means of a wheel or foot propulsion system.

According to one of constructional embodiments of the proposed invention, said airborne transport means may be in the form of delivery robots using air propellers for travelling or blades.

According to one of possible embodiments of the proposed invention, the goods display and distribution subsystem may comprise a refrigeration section.

A particular embodiment of the proposed invention allows for a retractable ramp for ground transport means.

The robotic manipulator mechanism used in the proposed invention may be equipped with a digital video surveillance means for controlling the processes of travelling and preparation for dispensing the products selected by the user.

The fully robotic technological item is proposed, which is preferably a self-propelled cargo vehicle predominantly controlled in unmanned mode, whose operation monitoring, in particular, implying the execution of the main function assigned to it, can be carried out remotely in an external control center for road transport quality and safety. The self-propelled vehicle is structurally an independent smart system and is operated automatically according to the pre-established software functionality. However, the peculiarities of the execution, including the software, allow transitions to manual piloting and control of the equipment, as well as allow independent decision-making and signal processing in theoretical cases of primary non-performance of the assigned functionality or in case of other unplanned emergencies leading to the failure of computer system hardware settings.

According to the intended purpose, the proposed robotic technological item is designed to distribute products, including life-saving products, to hard-to-reach parts of an area whose inhabitants may be in dire need of obtaining essential life-supporting supplies, the delivery and centralized distribution of which by conventional known methods may be limited because it requires fund/material collection, route studies, and preparation of specialized ground and airborne equipment requiring significant resources, including full-time drivers, vendors, loaders and other necessary personnel involved in the development of an event plan.

The proposed self-propelled smart vehicle largely compensates for the disadvantages listed in the above paragraph by having, in its preferred embodiment, unmanned control and automated mechanisms for the preparation and centralized sales of products, which, in combination with the off-road potential of the cargo vehicle, contributes to the delivery of the required goods to a certain location with the possibility of centralized automatic sales to the population quickly, accurately and without interruptions, and most importantly without the use of a live workforce prone to interruptions in the work process, slowdowns, errors and inaccuracies in transmission, as well as other actions negatively affecting the quality of services provided.

The basic features of the proposed self-propelled smart vehicle for delivery and distribution of products, allowing to realize the functionality assigned to it, is its performance on the basis of a cargo vehicle with the off-road potential which is systematically divided into the navigation and steering part, the goods display and distribution part and the delivery subsystem, the union of which forms a distribution structure containing, in particular, stationary and mobile equipment with detachable components. The coordinated operation of said equipment allows for a prompt and error-free display of the current product range and on-site dispensing of the purchased goods or delivery of the selected goods from the presented product range, ensuring accuracy and hygienic safety during the transportation.

Achieving a high level of technological effectiveness, optimal performance, as well as stable and reliable communication capabilities, according to the inventive concept, is ensured (caused), in particular, by the presence of partially detachable and stationary equipment in the robotic system with intelligently adaptive functionality that supports the possibility of consumer review and subsequent purchase. At the same time, said partially detachable and stationary equipment is based in the goods display and distribution part and in the delivery part of the vehicle and implies the presence (operation) of robotic manipulator mechanisms that combine, in one design, the two-axis load platforms and the coordination platform. One of the platforms is a contact one with the actuator necessary for contact with the products and for subsequent contact with the nodes of the buffer loading subsystems that send and receive the other of the parts which constitute temporarily detachable delivery modules in the form of ground and airborne transport means provided with their own landing areas in the system to support their performance according to the embedded software functionality.

Thus, the above-proposed implementation of the claimed robotic system for storing and dispensing products, taking into account its characteristics and technical features, forms a set of features sufficient to achieve the above-specified technical result which consists in implementing the purpose of creating an all-terrain vehicle configured, with moderate energy consumption and reduced material costs, to reach hard-to-reach areas and to carry out, in a highly efficient cyclic mode, the sale (including remote) and dispensing of products specified by a consumer, which are delivered to the latter according to a developed algorithm that provides for careful warehousing/storage, high-speed collection/preparation and precise positional issuance/delivery.

### BRIEF DESCRIPTION OF DRAWINGS

FIG. 1 shows a general view of a robotic all-terrain system prepared for operation;

FIG. 2 shows a diagram of the placement and movement of ground transport means;

FIG. 3 schematically shows the internal structure of a goods display and distribution subsystem;

FIG. 4 shows an operational version of the interaction of the equipment of the goods display and distribution subsystem and a delivery subsystem;

FIG. 5 shows a design version of a robotic manipulator mechanism and its operational capabilities;

FIG. 6 shows a version of the location and movement pattern of airborne transport means, top view;

FIG. 7 shows a design version of an additional robotic manipulator mechanism, side view;

FIG. 8 schematically shows a version of the installation of racks with products in the goods display and distribution subsystem.

### DETAILED DESCRIPTION OF THE INVENTION

The proposed invention is explained by specific examples of execution and realization, which, however, are not the only possible ones, but clearly demonstrate the achievement of the given technical result, as well as the solution of the existing technical problem by the specified set of essential features.

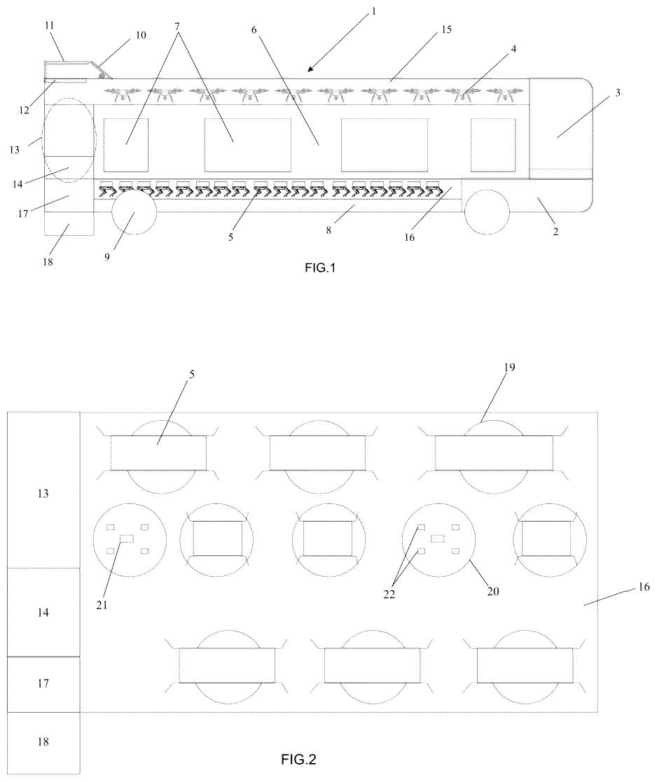

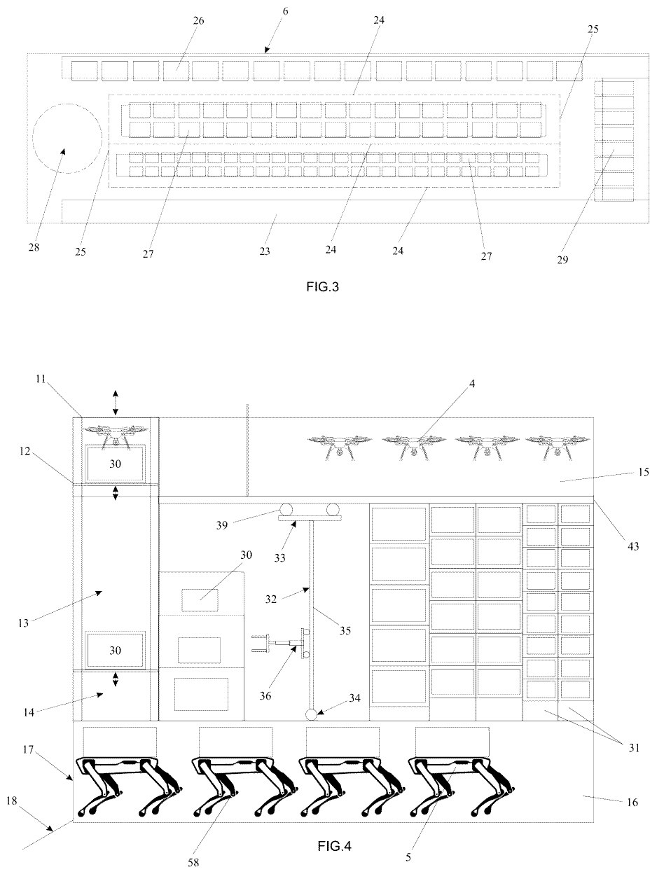

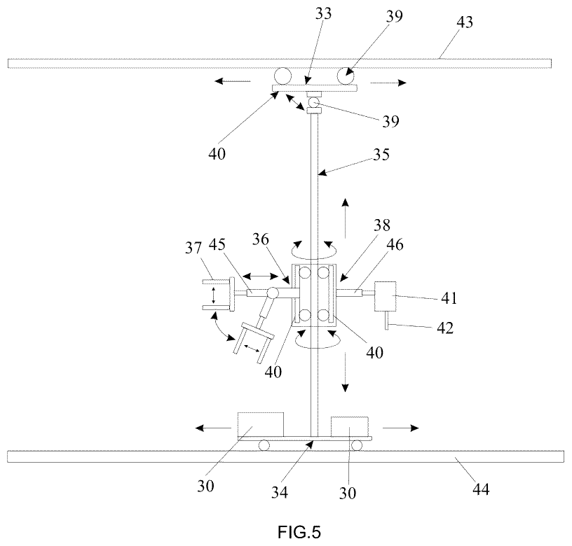

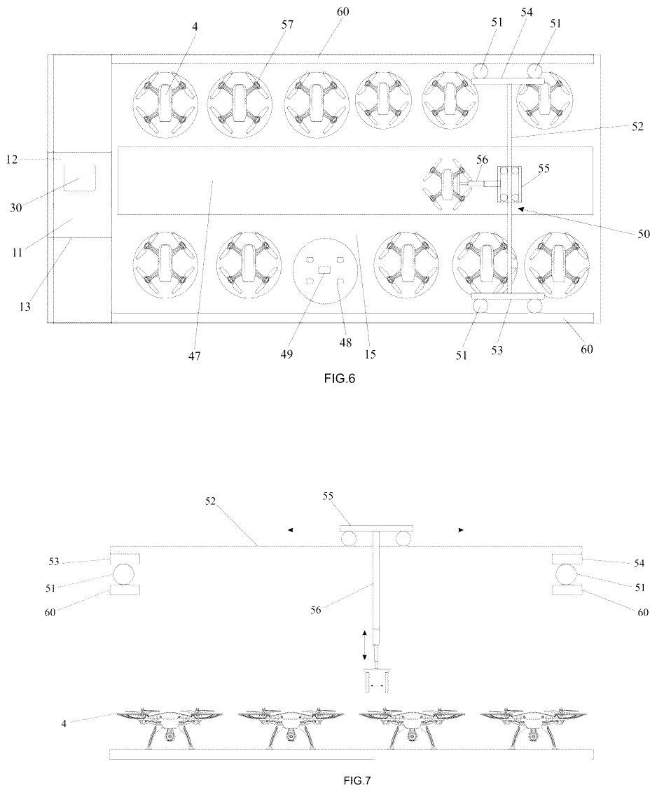

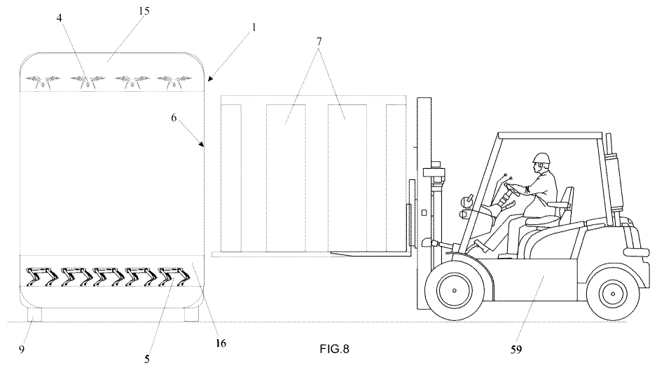

In presented FIGS. 1-8, the following parts and components of the proposed self-propelled smart vehicle are designated by numerical positions:
1—all-terrain vehicle;
2—vehicle engine;
3—multi-purpose control unit;
4—airborne transport means;
5—ground transport means;
6—display section;
7—groups of unformed racks of a goods display and distribution subsystem;
8—charging battery station;
9—means for improving terrain passability;
10—air flow barriers;
11—upper hatch for entry/exit of airborne transport means;
12—lower access hatch combined with a magnetic landing platform;
13—elevator system for moving goods;
14—area for feeding formed sets of goods to an elevator platform for their subsequent issuance;
15—compartment for placing airborne transport means;
16—compartment for placing ground transport means;
17—gateway for entry/exit of ground transport means;
18—retractable ramp for ground transport means;
19—landing area for ground transport means;
20—free landing area for ground transport means;
21—contact element for maintaining a charging level of a ground transport means;
22—magnetic fasteners for stabilizing ground transport means;
23—refrigeration section;
24—longitudinal passages for moving a robotic manipulator mechanism;
25—transverse passages for moving the robotic manipulator mechanism;
26—single-sided docking multi-level racks;
27—double-sided docking multi-level racks;
28—loading and unloading area;
29—end single-sided racks with increased capacity;
30—sets of goods;
31—cells with groups of goods;
32—robotic manipulator mechanism;
33—upper two-axis load platform;
34—lower coordination platform;
35—connecting transport bridge;
36—contact two-axis load platform;
37—actuator;
38—additional contact two-axis platform;
39—platform servo drives;
40—platform support surfaces;
41—compressor-type packaging device;
42—packaging device nozzle;
43—upper guides for moving the upper two-axis load platform;
44—floor section of the goods display and distribution subsystem;
45—base of the actuator;
46—base of the packaging device;
47—technological passage for transporting airborne transport means;
48—magnetic fasteners for stabilizing airborne transport means;
49—contact element for maintaining a charging level of an airborne transport means;
50—additional robotic manipulator mechanism;
51—servo drives of the additional robotic manipulator mechanism;
52—connecting bridge of the additional robotic manipulator mechanism;
53—first support pad of the additional manipulator mechanism;
54—second support pad of the additional manipulator mechanism;
55—contact pad of the additional robotic manipulator mechanism;
56—actuator of the additional robotic manipulator mechanism;
57—propellers for movement;
58—foot movers;
59—loader;
60—side parts of the goods display and distribution subsystem, along which the additional robotic manipulator mechanism moves.

Thus, the proposed self-propelled smart vehicle is designed for distribution, mainly retail, of products on display. The products under consideration are various, but mainly these are food products, including vital ones (water, flour, cereals, meat, fish, vegetables, etc.).

The listed products are intended for consumers who are mainly located outside the boundaries of infrastructure settlements and, accordingly, have restrictions in visiting stationary network and local retail outlets, but need fresh products that ensure normal human life.

The self-propelled smart vehicle is made in the form of an all-terrain vehicle 1 which belongs to a cargo version with off-road potential. At the same time, the vehicle is controlled in an unmanned mode.

The all-terrain vehicle 1 is systemically divided into a navigation and steering subsystem, a goods display and distribution subsystem, and a delivery subsystem which interact with each other.

The combination of the above-listed main subsystems forms an autonomous and conditionally dispersed structure that allows for the active, dynamic distribution of products and at the same time popularization of some of their types that may be in demand among the population deprived of the opportunity, due to the terrain, to eat a variety of products.

Such popularization and distribution structure, prepared on the basis of the all-terrain vehicle 1, is fully automated and has the technical capability of remotely monitoring the functioning of detachable and stationary autonomously operating equipment, the design, location and operation features of which constitute a key part of the inventive concept of the proposed self-propelled smart vehicle.

According to the design of the all-terrain vehicle 1, the detachable and stationary equipment of the goods display and distribution subsystem and the delivery subsystem is synchronized and communicated with the equipment of the navigation and steering subsystem and has an automatically adaptive functionality for maintaining consumer visibility and the final receipt by an interested person of a selected category of goods.

In this case, the navigation and steering subsystem comprises a multi-purpose control unit 3, which includes a unit for controlling the movement and localization (basing) of the smart vehicle itself in the form of the all-terrain vehicle 1 and a unit for controlling the stationary and movable autonomously functioning components, with the possibility of their undocking (detaching), which located in the goods display and distribution subsystem and the delivery subsystem with the possibility of temporary separation of individual modules therefrom.

The autonomously operating components of the goods display and distribution subsystem have a coordination and distribution part, which is made in the form of at least one controlled robotic manipulator mechanism 32.

The design of the robotic manipulator mechanism 32 is based on the design combination of an upper two-axis load platform 33, a lower coordination platform 34 and a contact two-axis load platform 36, respectively. The upper two-axis load platform 33 and the lower coordination platform 34 are supporting, and the third one is conventionally provided between them and is the contact two-axis cargo platform 36. In this case, the upper two-axis load platform 33 is located in the upper support part of the goods display and distribution subsystem, and the lower coordination load platform 34 is located in the lower support part of the goods display and distribution subsystem, and the contact two-axis load platform 36 is installed between them on a vertical connecting transport bridge 35. Accordingly, the designed unit can, at least, longitudinally move along a longitudinal passage 24 due to the ability to move along the support surfaces of the upper two-axis platform 33 and the lower coordination platform 34.

The contact two-axis load platform 36 is equipped with an actuator 37 which is configured to grip products for the purpose of controlling their spatial position, including the possibility of placing products on a one-sided docking multi-level rack 26 for the purpose of their visual inspection by an interested person through an existing display (exhibition) section 6 of the goods display and distribution subsystem.

Between the upper two-axis platform 33 and the lower coordination platform 34, there is an additional contact two-axis cargo platform 38 which is installed on the connecting transport bridge 35 and equipped with a compressor-type packaging device 41 for wrapping sets of goods 30 with a protective coating. The compressor-type packaging device can carry out packaging of sets of goods or individual goods with shrink film, PVC film, another type of film or packaging material, and can also fill the packaging, in which the goods are placed, with fillers made of foam plastic, PVC, paper and other types of fillers depending on the configuration.

Thus, the contact two-axis load platform 36 and the additional contact platform 38 form a single production unit that that functions in a synchronized way and also independently of each other within the framework of the work operation being performed, while the possibility of rotation of the connecting transport bridge 35 around the axis provides additional functionality to the manipulator robotic mechanism 32.

The base of the actuator 37 and the base of the packaging device 41 are made telescopic, while their working parts are installed with the possibility of displacement relative to their bases.

It should be noted that structurally the upper two-axis platform 33 consists of at least two support surfaces 40 moving along upper guides 43 by means of servo drives 39. In this case, said movement can be longitudinal back and forth. On the support surfaces 40, a connecting beam is equipped transversely with the upper guides 43, along which (from one side of the all-terrain vehicle to the other side) the coordinate platform installed on it moves due to the servo drives. The vertical connecting transport bridge 35 is attached with its upper part directly to the coordinate platform.

The lower coordination platform 34 is a load platform which is made of durable material (plastic, metal, etc.) for the purpose of possible placement of assembled sets of goods 30 on it by the robotic manipulator mechanism 32, and which is equipped with wheels or rollers for movement along the floor section of the goods display and distribution subsystem 44. Thus, the floor section of the goods display and distribution subsystem 44 acts as a support surface for the lower coordination platform 34. The movement of the lower coordination platform 34 along the floor section of the goods display and distribution subsystem is carried out by inertia due to the servo drives that set in motion the support surfaces 40 and the coordinate platform installed on the connecting beam.

Accordingly, the entire designed unit of the robotic manipulator mechanism 32 has the ability to move longitudinally along the longitudinal passage 24 due to the ability to move along the support surfaces of the upper two-axis platform 33 and the lower coordination platform 34 and the ability to move transversely along the transverse passage 25 due to the ability to move the coordinate platform, to which the vertical connecting transport bridge 35 is attached, along the connecting beam and the movement of the lower coordination platform 34 along the support surface. Thus, the entire designed unit of the robotic manipulator mechanism 32 can move along all the longitudinal and transverse passages with sufficiently high positional accuracy. The configuration of the actuator 37 of the contact two-axis load platform 36 also implies loading and unloading positional contact with the previously mentioned autonomously operating components of the delivery subsystem.

One part of the autonomously operating components of the delivery subsystem is automated auxiliary equipment in the form of mutually coordinated buffer systems with the ability to distribute and lift goods, performing the passage, sending and receiving of the other part which constitutes the temporarily detachable modules in the form of ground transport means 5 and airborne transport means 4. In particular, an elevator system 13 and an area 14 for preparing the delivery of formed sets of goods to an elevator platform for the purpose of their subsequent issuance should be considered as said buffer parts.

The ground transport means 5 are made in the form of delivery robots moving with the help of a wheeled or foot propeller 58.

The airborne transport means 4 are made in the form of delivery robots using propellers 57 or blades for movement.

The equipment of the goods display and distribution subsystem provides for the presence of single-sided 26, double-sided 27 docking multi-level racks, as well as end single-sided racks 29 of increased capacity. In addition, it may include a refrigeration section 23 equipped with refrigeration equipment to maintain an acceptable storage temperature for perishable categories of products.

The proposed self-propelled smart vehicle for distributing products can be implemented as follows.

It should be noted that the purpose of the subsequent description of the proposed invention is not to limit it to a specific design and embodiment, but, on the contrary, to cover all sorts of additions that do not go beyond the scope of the appended claims.

The all-terrain vehicle 1 is autonomous in operation and can be unmanned. Unmanned control becomes possible due to the presence of the multi-purpose control unit 3 which includes the unit for controlling the movement and localization (basing) of the vehicle. This unit is equipped with a means of access to the Internet via public packet radio communication GPRS and a receiver of satellite navigation signals GPS/GLONASS, which allows constant communication with an external monitoring and control center and, accordingly, to receive all the necessary navigation data required to build routes taking into account the landscape features of the area. Unmanned passage of routes to the destination is controlled by the external monitoring and control center, the parameters of the movement of the vehicle 1 are recorded online in the external monitoring and control center and, in the event of emergency situations, the manual remote-control mode can be used. If it is impossible to continue moving, a maintenance vehicle with qualified personnel is sent to the place where the vehicle 1 is stopped to be able to switch to manual control to complete the assigned production tasks.

Autopiloting of the vehicle 1 is supported by software of the multi-purpose control unit 3 which receives signals from GPS/GLONASS satellites and coordinates the vehicle road systems in real time. All-round cameras, traffic monitoring cameras, parking radars, motion sensors, lidars and other auxiliary systems can be used as safety equipment.

As already indicated, the proposed all-terrain vehicle 1 comprises the multi-purpose control unit 3 which controls movement and monitors the operation of the mobile, stationary and temporarily detachable components of the subsystems used. For off-road driving, the vehicle 1 has an all-terrain configuration, and means 9 for improving terrain passability are used. Electric engines are used as propulsion systems, but internal combustion engines can also be used. Structurally, the vehicle can be divided into three levels-lower, middle and upper. The lower level contains a compartment 16 for accommodating ground transport means 5, a charging battery station 8, an engine 2, and auxiliary equipment for ensuring the movement of the ground transport means 5. The middle level contains the equipment of the goods display and distribution subsystem and the navigation and steering subsystem (the multi-purpose control unit 3, the racks 26, 27, 29, a loading and unloading section 28, the robotic manipulator mechanism 32, the display section 6, the elevator system 13 for moving the goods). The upper level contains a compartment 15 for accommodating airborne transport means 4, as well as auxiliary equipment for joining and coordinating the movements of the transport means 4 and other technical equipment.

Before starting to follow an agreed route, groups of racks 7 of the goods display and distribution subsystem are loaded in a distribution warehouse center. Said loading is performed using a loader 59 which places the groups of the unformed racks 7 in the space of said subsystem, forming the one-sided multi-level racks 26, the two-sided 27, as well as the end racks 29 of increased capacity. The groups of the unformed racks 7 are delivered inside the all-terrain vehicle 1 through the display (exhibition) section 6, which is transformed for the duration of loading and unloading operations and provides a free passage.

The complete set of racks can vary; however, there must be the longitudinal 24 and transverse 25 passages between the racks for moving the robotic manipulator mechanism 32.

The distribution warehouse center is a large sorting station serving large areas with a population in need of receiving various products, including fresh food products.

The product groups are pre-arranged in cells 31 of the unformed racks 7, which subsequently form the racks 26, 27 and 29 (for example, in one cell there are packs of juice of a certain type, in another cell-packs of snacks of a certain type, in a third cell-packs of ketchup of a certain type, and so on, including non-food products). Thus, the cells 31 differ in size and content. The arrangement of the racks by the product groups, as a rule, is carried out taking into account the opinion and needs of the population living in certain remote areas and on the basis of conducted research of statistical data on the purchase of goods in a specific territory.

Before placing the product groups in the cells 31 of the unformed racks 7, each product is scanned, and records of product compliance with the specific cells 31 are entered into the multi-purpose control unit 3 which also receives information on the exact quantity of product in the cell, its assortment in the cell 31, its description and expiration date (for food products).

It should be noted that after placing the groups of the unformed racks 7 and forming the racks 26, 27 and 29, the connection of the product groups with the specific cells 31 of the racks 26, 27 and 29 recorded in the distribution center via the control unit 3 is also sent to the server of the external control center. Said connection is established by scanning QR codes or bar codes applied to the corresponding cells of the formed racks 7.

Given the main purpose of the robotic all-terrain system-storage and release of products-the products placed in the cells 31, the information about which is entered into the multi-purpose control unit 3 and transmitted to the server of the external control center, are identified as goods located in the cell 31 with the product groups.

The resulting internal storage system for the product groups, dispersed in the goods display and distribution subsystem, contains a large number of the cells 31 with the product groups, which may differ in size; however, most of them are standardized for the most popular product sizes, which is determined by the practice of delivery services and the accumulated database of products most often purchased in a particular region. The cells 31 with the product groups are divided into cells of extra-small, small, medium, large, extra-large and non-standard sizes.

In the distribution warehouse center, in addition to loading and scanning the products, information about the route, the coordinates of the destination, terrain conditions and other route parameters is also entered into the multi-purpose control unit 3. The software of the multi-purpose control unit 3 processes the information, sends it to the external control center and, after the route conditions have been agreed upon and the all-terrain vehicle 1 is ready, departure to the destination for the sale of the contents is permitted.

The all-terrain vehicle 1, under the control of the external control center, departs along the agreed route to the destination. On the way to the destination, the vehicle movement and localization control unit of the multi-purpose control unit 3 re-checks the destination coordinates and, thanks to the GSM/GLONASS satellite navigation signal receiver, creates an optimal route map based on the remoteness of the point and the possibility of unimpeded access to it.

The movement and localization control unit of the multi-purpose control unit 3 is equipped with a processor programmed, in particular, to count the optimal number of sets of goods 30, including, relying on information about possible sets of goods ordered in advance, calculate the optimal number of the ground 5 and airborne 4 transport means, as well as check the operability of the necessary ground 5 and airborne 4 transport means. Based on the received data, the control unit 3, using the developed mathematical model of counting, selects the optimal exact location of the all-terrain vehicle 1 and the optimal operating parameters of the stationary, movable and detachable equipment (the racks 26, 27 and 29, the robotic manipulator mechanism 32, the airborne transport means 4, the ground transport means 5, the elevator system 13, etc.).

It is worth noting that after the assembly of the all-terrain vehicle 1 in the distribution warehouse center is completed and when the movement process has begun, the multi-purpose control unit 3 is used, in particular, to determine the control time of arrival and deployment of the equipment, develop a scheme for displaying the products by placing them on the one-sided docking multi-level rack 26 which is viewed through the display (exhibition) section 6, and determine the maximum permissible range of movement of the transport means 4 and 5. Thus, the control system of the proposed all-terrain vehicle 1 determines the approximate energy and time costs for performing the production operation for the effective sale of products in one target trip.

Upon arrival at the established place of sale of the products, the all-terrain vehicle 1 begins to sell them.

Thus, the production process control, consisting in the transfer of products, as well as their presentation for review, is carried out by the multi-purpose control unit 3 connected via the Internet to the external control center. The control unit 3 comprises a separate system unit for controlling the stationary and movable autonomously operating components provided with the possibility of their temporary separation. The control unit 3 contains software, by means of which the transfer of information on incoming orders and on the operation of the system equipment is ensured.

The main algorithm for the sale of products is a stationary sale upon the arrival of the all-terrain vehicle 1 at the designated location. The all-terrain vehicle 1 may contain, on its outside, appropriate signs and markings indicating the purpose of the vehicle, it can also be thematically painted. In this way, potential consumers learn about the purpose of the robotic system and can make purchases.

The offer of products for sale is carried out through the display (exhibition) section 6 by displaying the products for viewing or remotely by transmitting information about the trade assortment via the Internet or other wireless communication to consumers connected to the sales network of the self-propelled smart vehicle; the offer of products can also be carried out in other ways, including by placing a special terminal (for example, a touch screen) on the outside of the all-terrain vehicle 1 in the area of the display (exhibition) section 6, which is equipped with software for selecting and forming a basket of ordered products from the current product range, as well as a payment terminal.

In addition, sales are carried out by ordering products via the Internet or other wireless communication remotely, followed by delivery of the products to a consumer using the ground 5 and airborne 4 transport means.

Data about the order of a certain product is received via software in the multi-purpose control unit 3 and/or the external control center.

The delivery of products purchased at the location of the all-terrain vehicle 1, or the delivery of products purchased remotely, is carried out using the ground 5 and/or airborne 4 transport means.

Thus, after the multi-purpose control unit 3 and/or the external control center receives information about an order for a certain product that is displayed via the display section 6, or is available in the cells 31 with the product groups on the racks 26, 27 or 29, the separate system control unit 3, processing the received signal, generates a command to the robotic manipulator mechanism 32 in accordance with the embedded algorithm of actions to prepare for goods withdrawal from the cells with product groups 31, formation of a set 30 of products and issuance of the corresponding set 30 of products.

The robotic manipulator mechanism 32 has the technical capabilities of an autonomous system and is in constant wireless contact with the control unit 3 and the external control center.

The formation of the set 30 of products occurs within the loading and unloading section 28, where a package in the form of, for example, boxes of various shapes and sizes is stored. The selection of a required package, the arrangement of goods inside the package, including the covering of a certain product inside the set with a protective coating by means of the packaging device 41, occurs according to an algorithm that is developed each time by the system unit of the multi-purpose control unit 3 based on information about the received order.

Thus, upon receiving a certain signal about the need to select a package of a certain size and shape, the robotic manipulator mechanism 32 removes the package of the required size and shape from the corresponding cell in accordance with the algorithm sent to it and places within the loading and unloading section 28. Further, upon receiving a signal about the need to select one or more goods, and when moving, in particular, along the longitudinal passages 24 and transverse passages 25, the robotic manipulator mechanism 32 finds the required cell 31 with the goods corresponding to the order and removes the goods using the actuator 37 configured as a manipulator gripping element having movable clamping sections that hold the goods.

Then, upon receipt of a corresponding signal from the system unit of the multi-purpose control unit 3, the product can be covered with a protective coating by means of the packaging device 41, which has a nozzle for applying the protective coating (for example, heat-shrinkable film, PVC film, another type of film or packaging material), and can also fill the package, in which the products are placed, with fillers made of foam plastic, PVC, paper and other types of fillers.

After that, the robotic manipulator mechanism 32, holding the goods with the help of the actuator 37, drives up to the loading and unloading section 28 and places the goods in the package. The algorithm is repeated until all the goods from the received order are collected in the package. Then, the robotic manipulator mechanism 32 closes the package and transmits information about the readiness for issuance of the formed set 30 of goods to the multi-purpose control unit 3. It should be noted that all packages are identified using bar codes or other designations that can be applied to them in advance in the distribution warehouse center or can be applied directly by the robotic manipulator mechanism 32 in the loading and unloading section 28 after the goods have been packaged.

Receiving the information signal about the readiness to issue the set 30 of goods, the multi-purpose control unit 3 activates the action of the corresponding ground transport means 5 or the airborne transport means 4, which at this time are located inside the all-terrain vehicle at their docking places in the compartments 16 and 15, respectively.

As the ground transport means 5, known developments can be used, in particular, for example, robots Marathon Robotics or Gita, Piaggio (see http://robotrends.ru/robopedia/ulichnye-roboty-kurery).

As the air transport means 4, known developments can be used, in particular, for example, models of the Aerones company (see https://rg.ru/2017/05/15/na-video-sniali-pervyj-pryzhok-cheloveka-s-drona.html).

The transport means 4 and 5 used in this invention comprise means for recording and transmitting information for the purpose of providing information and intermediary services (surveillance cameras, communication means, executive bodies, means for holding and capturing goods, non-volatile memory, etc.).

The autonomous transport means used herein-ground 5 and airborne 4-are equipped with an Internet access device, for example, via mobile communications (SIM cards), which allows them to be constantly in touch with the multi-purpose control unit 3 and with the external control center. In addition, the transport means used herein are equipped with GPS/GLONASS modules and information can be transmitted both to the control unit 3 and to the external control center.

Depending on the parameters of the set of goods (size, weight, shape) and the generated delivery algorithm, the autonomous transport means, for example, the airborne transport means 4, having all the necessary functionality for autonomous operation, takes off by means of the propeller 57 and detaches from a magnetic fastener 48. Then, according to the algorithm embedded in the microprocessor or according to the algorithm transmitted to it by the control unit 3, it moves through a technological passage 47 for transporting airborne transport means and enters the opening of the elevator system 13 under a lower access hatch 12 and waits until the set 30 of goods, installed on command by the robotic manipulator mechanism 32 on the movable platform of the elevator system 13, rises to the level of the compartment 15, goes beyond the elevator shaft and docks with the airborne transport means 4 via a magnetic system activated at the moment of docking and having interacting parts located both on the set 30 of goods and on the airborne transport means 4 itself (the fastener can be performed in another way).

As an alternative, the airborne transport means 4 can move in the compartment 15 using an additional manipulator robotic mechanism 50, which is made in the form of a structural combination of a first support pad 53, a second support pad 54 and a contact pad 55. In this case, the support pads 53 and 54 move along horizontal longitudinal guides 60 and are connected by a transport bridge 52, on which the contact pad 55 is installed, which can shift along the transport bridge 52 and rotate and is equipped with an actuator 56 having a gripping contact magnetic device for temporarily holding and moving the airborne transport means 4.

If the ground transport means 5 is selected from the group of autonomous transport means, then, in accordance with the previously received command, it moves independently along the compartment 16 and waits directly near the shaft of the elevator system 13. When the robotic manipulator mechanism 32, by means of the actuator 37, moves the set 30 of goods through the feeding area 14 onto the movable platform of the elevator system 13, the platform goes down and the set 30 of goods, having passed the protective barrier, is installed on the working platform of the ground transport means 5 and is fixed by means of the already indicated magnetic system.

Thus, the ground 5 and airborne 4 transport means are ready to transfer the finished set 30 of goods to the recipient.

With the help of the automatically sequentially opening lower access hatch 12 and upper hatch 11, the airborne transport means 4 with the set 30 of goods goes outside and searches for the spatial position and route within the framework of the work operation being performed.

The ground transport means 5 has all the necessary functionality for autonomous operation, and independently, upon receiving a control signal, according to the embedded software algorithm, exits the compartment 16 and goes out through a gateway 17 along a retractable ramp 18 and also searches for the spatial position and route within the framework of the work operation being performed.

At this stage, this group of autonomous transport means (the group ready to transfer the set of products) has previously received the necessary information about the recipient, including video data that will allow it to be identified and the set 30 of products to be transferred to its destination, or there is a route formed by the multi-purpose control unit 3 to the place of delivery of the set 30 of products and identification data of the recipient of the products.

On the body of the ground 5 and airborne 4 transport means, modules for working with NFC components, as well as video cameras for reading QR codes, bar codes, etc. are installed. The ground 5 or airborne 4 transport means performs a spatial search-establishes the recipient, compares the actually determined parameters with the data received when ordering the product and, if there is a match, a command is given to demagnetize the system for holding the set 30 of goods, giving the latter directly into the hands of the recipient. In this case, the signal on the identification of the recipient is sent to the multi-purpose control unit 3 and to the external control center, the entire process of receiving the set of goods is recorded by the video camera of the transport means 4 and 5, after which the information is sent to the control unit 3 and to the external control center for temporary storage as evidence of the receipt made in order to avoid any controversial issues. At the same time, the recorded information on the receipt of the set 30 of goods is used by the external control center for the subsequent formation of a receipt and its sending by any available method to the address of the recipient. In addition, the recipient can be identified by reading a special code (for example, a QR code) from the recipient's device, generated by a program for receiving and processing orders of the multi-purpose control unit 3 and/or the external control center.

Then, the ground 5 and airborne 4 transport means can be sent back to the all-terrain vehicle 1 for basing and recharging or for receiving the next sets 30 of goods selected by another user.

The ground transport means 5 that has completed the task goes, in the reverse order, to the all-terrain vehicle 1, i.e., ascends the retractable ramp 18 and through the gateway 17 enters the compartment 16, where it either occupies a free landing area 20 and is charged by means of a contact element 21 or is placed in the elevator system shaft area awaiting a new set 30 of goods.

Having completed its task, the airborne transport means 4 also passes, in the reverse order, into the all-terrain vehicle 1 through the upper hatch 11 and the lower access hatch 12, where a new set 30 of goods is awaiting near the shaft of the elevator system 13, or passes along the compartment 15 and occupies a free area, within which it recharges the battery by means of a contact element 49.

It should be noted that when the ground 5 or airborne 4 transport means moves inside the all-terrain vehicle 1 and begins to leave its limits or comes in for landing for the purpose of basing or replenishing with a set of goods, signals are transmitted to the multi-purpose control unit 3 and to the external control center-this occurs by means of wireless data transmission and, at the moment, a safe maneuvering program is initiated, namely:
the transport means 4 and 5, if necessary, turn on light and sound signals indicating movement and appearance;
electronic means for viewing the transport means 4 and 5 produce effective video filming of the environment for maneuvering safety;
the received video data are analyzed by the software of the multi-purpose control unit 3 for the presence of moving objects (people, animals, etc.);
in the event of the presence of any obstacles, the transport means 4 and 5 move to the side, the environment is analyzed again by means of minicomputers of the transport means themselves and the multi-purpose control unit 3.

Upon completion of the sale and issuance of all products, all transport means 4 and 5 return to their compartments 15 and 16, the all-terrain vehicle 1 reports this to the external control center and, after receiving permission to depart, the smart vehicle returns to the distribution center to prepare for a new trip. Also, the command to return all transport means 4 and 5 to their compartments 15 and 16 and the departure of the all-terrain vehicle 1 to the distribution center can be given by the external control center based on the analysis of product balances in the all-terrain vehicle 1 or for technical reasons.

One of the possible algorithms for distributing products is a targeted or purposeful search for a potential consumer. In particular, the all-terrain vehicle 1, through the synchronized operation of the control unit 3 and the external control center, performs checking/scanning of the surrounding space, and in the event of a potential consumer being detected, through digital video monitoring means, it sends control signals through the embedded software algorithm to the control mini-computers of the ground 5 and/or airborne 4 transport means.

Having received the primary control signal, the ground transport means 5 and/or the airborne transport means 4 must go outside to communicate with potential consumers (interested persons wishing to receive the products).

The exit of the ground transport means 5 and/or the airborne transport means 4 from the all-terrain vehicle 1 is carried out according to the algorithm described above, with the exception of the part of attaching sets 30 of goods to the ground transport means 5 and/or the airborne transport means 4.

Once in the vicinity of the interested person, the airborne transport means 4 or the ground transport means 5, using the available technical functionality, communicates with the interested person, including audio or video communication in the format of a presentation of the range of available goods. The presentation is carried out within the framework of the available software, which allows the consumer, due to the operation of the hardware of the autonomous transport means 4, 5, to determine for themselves the type and number of goods of interest and to make a voice or written order (via an input device) about the desire to purchase the corresponding goods. Payment for the goods is made either directly using the terminal of the self-propelled all-terrain vehicle 1 or using the software installed by the consumer on their mobile device.

After recording and processing the signal concerning the received product order, the airborne 4 and/or ground 5 transport means, according to the embedded software algorithm, sends a signal about the formation of the set 30 of goods to the multi-purpose control unit 3 and/or to the external control center. Then, the multi-purpose control unit 3 and/or the external control center sends the corresponding signals to the goods display and distribution subsystem and the delivery subsystem about the formation of the sets 30 of goods and their issuance or delivery to consumers, according to the algorithm described above for the issuance of goods purchased at the location of the all-terrain vehicle 1, or the delivery of goods purchased remotely.

The previously indicated groups of autonomous transport means (participating in the targeted or purposeful search for a potential consumer and the acceptance of the “order”) can also periodically be sent back to the location of the self-propelled vehicle 1 and recharge the battery systems. Instead of them, other transport means 5 and 4, which are in standby or recharging mode at that time, can be sent to “accept orders”.

The groups of autonomous transport means (transport means 4 and 5) used can be interchangeable and perform a wide range of tasks for each other within the framework of the work operations performed.

The proposed invention can find wide application in the field of transportation and can be used to supply products to the population living in places remote from large settlements.

1. A self-propelled smart vehicle for retail distribution of displayed products intended for a consumer primarily located outside boundaries of infrastructural settlements, wherein the self-propelled smart vehicle is made as a preferably off-road cargo, usually unmanned vehicle systemically distributed into a navigation and steering subsystem, a goods display and distribution subsystem and a delivery subsystem which are configured to interact with each other;
wherein the subsystems are combined to form an autonomous and conditionally dispersed, primarily popularization distributing structure configured to remotely control operation of detachable and stationary autonomously operating equipment possessing automatically adaptive functionality for maintaining consumer visibility and final receipt of a selected category of goods;
wherein the navigation and steering subsystem comprises a unit for controlling movement and localization of the vehicle and a unit for controlling stationary and movable detachable autonomously operating components arranged in the goods display and distribution subsystem and in the delivery subsystem with an ability to temporarily detach individual modules from the subsystems;
wherein a coordination and distribution part of the autonomously operating components of the goods display and distribution subsystem is made as at least one controlled robotic manipulator mechanism based on a structural combination of a supporting upper movable two-axis load platform and a supporting lower movable coordination platform with at least one contact two-axis load platform provided therebetween on a connecting transport bridge;
wherein the at least one contact two-axis load platform is equipped with an actuator configured to grip a product in order to control a spatial position of the product, including creating a possibility of visual viewing of the product by means of an existing display section, as well as to provide subsequent loading and unloading positional contact with the autonomously operating components of the delivery subsystem, one part of which is automated auxiliary equipment made as buffer systems coordinated with each other and configured to perform goods distribution and lifting;
wherein the automated auxiliary equipment is configured to provide the passage, sending and receiving of the other part constituting the temporarily detachable modules implemented as ground and airborne transport means for which stationary landing areas are provided, the stationary landing areas supporting operability, providing for a possibility of docking/decoupling with a product selected by a user and searching for a spatial position within a framework of a work operation being performed.

2. The self-propelled smart vehicle of claim 1, wherein an additional contact two-axis load platform equipped with a compressor-type packing device for wrapping the products with a protective coating is installed on the connecting transport bridge between the supporting upper two-axis load platform and the supporting lower coordination platform of the robotic manipulator mechanism.

3. The self-propelled smart vehicle of claim 2, wherein the contact two-axis load platforms of the robotic manipulator mechanism are mounted on a pivoting stand rotating about an axis.

4. The self-propelled smart vehicle of claim 1, wherein the contact two-axis load platform of the robotic manipulator mechanism comprises an additional actuator configured to displace a working part relative to a base.

5. The self-propelled smart vehicle of claim 4, wherein the bases of the actuators are telescopic, and the working parts are equipped with crimping gripping elements.

6. The self-propelled smart vehicle of claim 1, wherein the ground transport means are configured as delivery robots travelling based on a wheel or foot propulsion system.

7. The self-propelled smart vehicle of claim 1, wherein the airborne transport means are configured as delivery robots using air propellers for travelling.

8. The self-propelled smart vehicle of claim 1, wherein the goods display and distribution subsystem comprises a refrigeration section.

9. The self-propelled smart vehicle of claim 1, further comprising a retractable ramp for the ground transport means.

10. The self-propelled smart vehicle of claim 1, wherein the robotic manipulator mechanism is equipped with a digital video surveillance means for controlling processes of travelling and preparation for dispensing sets of products.
